(19) United States
(12) Patent Application Publication
(10) Pub. No.: US 2005/0122542 A1
(43) Pub. Date: Jun. 9, 2005

(54) Variable data print engine

(76) Inventors: Galo Gimenez, Biguesei Riells (ES); Arnau Panosa, Barcelona (ES); Petar Obradovic, Vancouver, WA (US); Luca Chiarabini, Sant Cugat (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/727,241

(22) Filed: Dec. 3, 2003

(51) Int. Cl. G06K 15/02

(52) U.S. Cl. 358/1.18

(57) ABSTRACT

A variable data print engine is configured for processing print data. In one implementation, a filter is configured to filter print data, and to thereby create grouped records. An analyzer is configured to analyze the grouped records to extract templates used by the grouped records. A template merging procedure is configured to merge the extracted templates to produce a merged template to which material may be added to create a print job.

### RELATED APPLICATIONS

This patent application is related to U.S. patent application Ser. No. ______, titled “PPML to PDF Conversion”, filed on ______, commonly assigned herewith, and hereby incorporated by reference. This patent application is also related to U.S. patent application Ser. No. ______, titled “PDF Document to PML Template Translation”, filed on ______, commonly assigned herewith, and hereby incorporated by reference.

### BACKGROUND

Enterprise level software is available for the coordination of large amounts of information within businesses and corporations. Such software allows accounting, marketing and management groups within the corporation to control large amounts of data, and to thereby control production, inventory, shipping and other business functions. Accordingly, a large amount of information is contained within, and is available to, such software. Due to the growing complexity of running such business enterprises, this level of information availability is continually increasing.

One aspect of the marketing effort put forth by such corporations involves the production of printed advertising material. This is a very complex endeavor, due to a number of factors, a few of which include: the large number of products to be promoted; the number of different languages and currencies of the many countries in which the products will be sold; the variety of legal requirements of advertisements in various jurisdictions; and the different demographic markets to which promotions must be directed. Accordingly, a large number of promotional brochures, advertisements and other printed materials must be produced. Due to the factors listed, and others not mentioned, this is a very complex endeavor.

In an attempt to solve the need for large numbers of differently printed documents, PPML (personalized print mark-up language) was developed. PPML templates (PPML/T) are configured for insertion of data into available fields and for creation of a large number of custom print jobs. However, there is a considerable cost to the creation of such templates, which results in higher than desirable overall costs. Moreover, a considerable cost is incurred in obtaining data to fill such templates.

As seen above, enterprise level software has available to it considerable data. However, known systems have been ineffective at moving this data into PPML templates that can be consumed by digital presses. Accordingly, the cost of creating printed materials is a burden to most commercial, governmental and non-profit enterprises.

### SUMMARY

A variable data print engine is configured for processing print data. In one implementation, a filter is configured to filter print data, and to thereby create grouped records. An analyzer is configured to analyze the grouped records to extract templates used by the grouped records. A template merging procedure is configured to merge the extracted templates to produce a merged template to which material may be added to create a print job.

### BRIEF DESCRIPTION OF THE DRAWINGS

The following detailed description refers to the accompanying figures. In the figures, the left-most digit(s) of a reference number identifies the figure (Fig.) in which the reference number first appears. Moreover, the same reference numbers are used throughout the drawings to reference like features and components.

FIG. 1 is an illustration of an exemplary environment within which a variable print engine may be implemented.

FIG. 2 is a block diagram that illustrates an exemplary implementation of the variable data print engine of FIG. 1.

FIG. 3 is a flow diagram that describes an exemplary method by which the variable data print engine of FIG. 2 may be operated.

FIG. 4 is an expanded view of block 302 of FIG. 3.

FIG. 5 is an expanded view of block 304 of FIG. 3.

### DETAILED DESCRIPTION

A variable data print engine is configured for processing print data obtained from enterprise resource planning software containing a broad spectrum of information. In one implementation, a filter is configured to filter print data, and to thereby create grouped records sharing desired characteristics, such as media size. An analyzer is configured to analyze the grouped records to extract templates used by the grouped records. A template merging procedure is configured to merge the extracted templates to produce a merged template to which material may be added to create a print job. Accordingly, an efficient print system receives the considerable data available within enterprise level software, filters and analyzes the data, merges templates appropriately, and performs high-speed variable-data printing.

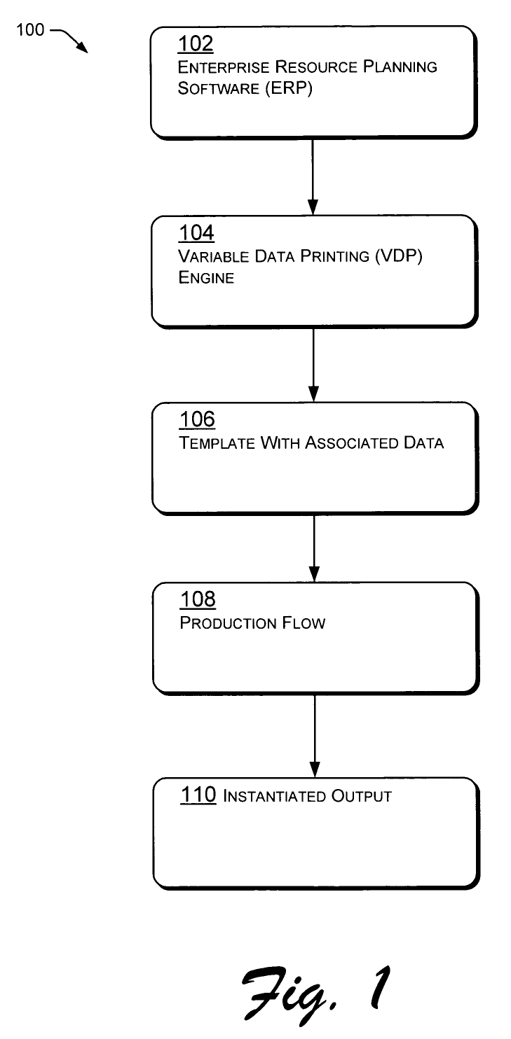

FIG. 1 shows an exemplary environment 100 within which a variable print engine may be implemented. At block 102 enterprise resource planning (ERP) software 102 is configured to provide wide-ranging functionality within an enterprise, such as a commercial for-profit enterprise, a governmental agency, a non-profit organization or other entity. Exemplary enterprise software can be configured to support accounting, marketing, management and other functions within the enterprise. Data on almost every aspect of the enterprise may be found within, or is processed by, the enterprise resource planning software 102. Such software is commercially known; an example of a manufacturer of such software is SAP (see: www.SAP.com).

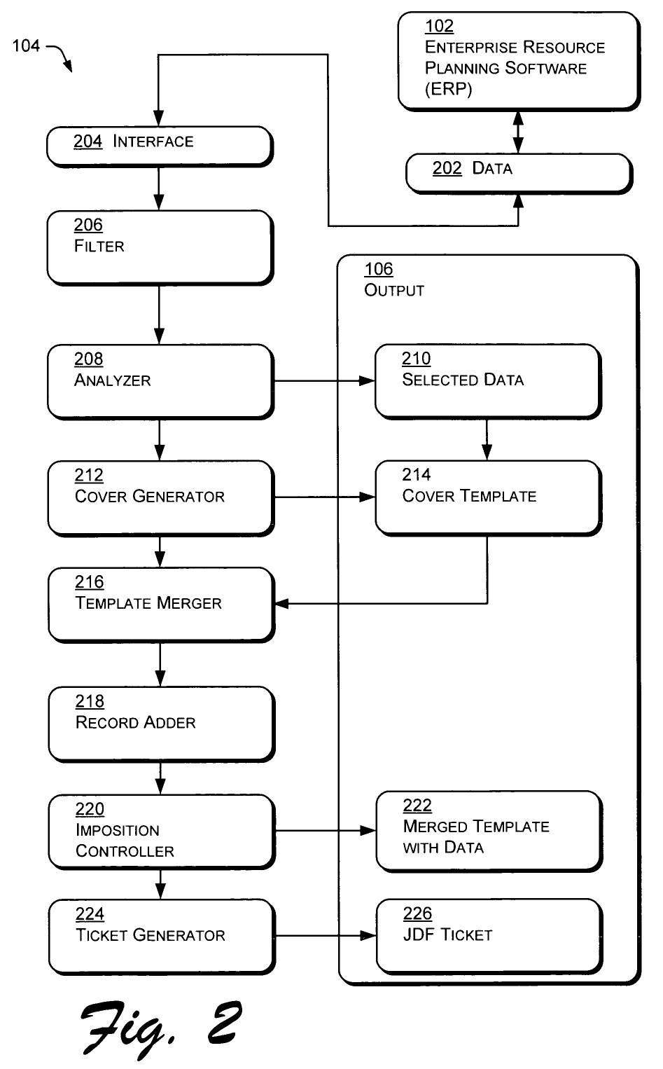

An exemplary PPML/T-based (i.e. personalized print markup language template based) variable data print engine 104 communicates with the ERP software 102 through an interface. As will be seen in much greater detail in the discussion of FIGS. 2-5, the variable data print engine 104 implements logic required to generate PPML/T (personalized print markup language templates) with data, as required, for the generation of print jobs for digital presses and other high-end printers or any other PPML template consumer. Accordingly, the variable data print engine 104 behaves like a sink, wherein a plurality of data records may be dropped. As will be seen in much greater detail, PPML templates associated with the record are then merged, data is filtered, analyzed and added to the merged template 106, and job tickets are generated, allowing the data to enter the production flow 108, where instantiated output 110 is created on digital presses, flat panel displays or other output devices.

FIG. 2 is a block diagram that illustrates an exemplary implementation of the variable data print engine 104, having an interface 204 through which data 202 may be obtained from ERP software 102. A filter 206 is configured to group records contained within data 202 into subsets to achieve a variety of goals. In general, the filter 206 groups print jobs according to a logical strategy that manages the data to result in efficient control over the work flow (i.e. print output).

In one implementation, materials (e.g. data 202 obtained from the ERP software 102) are grouped by filter 206 to result in grouped materials which are logically related by virtue of their relationship to a business or organizational entity. For example, the data may be grouped by the filter 206 according to business division, store location, department, product line or other characteristic. Similarly, where the organizational entity is an administrative branch of government, data may be grouped according to department, group, project, etc.

Similarly, the filter 206 may group data based on the printer to which the job will be sent. For example, where more than one type of printer is available, print jobs may be grouped logically based on print job requirements, such as the size of the job or the size of the paper required for the print job. In many cases, such grouping can be managed by rules which save paper. Additionally, media manipulation and trimming costs are saved, particularly where materials are the same or compatible sizes. For example, two A4-sized images can be put onto a single A3 sheet; similarly, four A5-sized images can be put onto a single A3 sheet. This type of grouping, performed by the filter 206, can be considered to be “imposition” grouping, wherein data which have characteristics which allow such an imposition are grouped together. Similarly, data may be grouped by the filter to segregate all the jobs according to the technology of the printer to which they are to be sent. For example, data may be grouped to segregate jobs to be sent to a digital press from jobs to be sent to a DesignJet level printer. As may be readily understood, other criteria for grouping print jobs may be imposed by the filter 206. For example, data 202 can be grouped according to print job priority. Therefore, by filtering and grouping in-coming data, the filter 206 facilitates press management.

An analyzer 208 is configured to analyze the data provided by the filter 206, and to extract from that data information 210. For example, the analyzer 208 may extract information about the templates used by records within the data supplied by the filter 206. Such information may include data on the field descriptors within the templates, the fonts used in the templates, and other similar data. In a typically implementation of the analyzer 208, meta data is extracted from templates, thereby obtaining information about the templates and related data (field descriptors, fonts, etc.) that will be needed. In particular, the analyzer 208 determines which templates found in the data 202 will be needed.

A cover generator 212 is configured to generate a cover template 214 that may be appended to the top of a document to be generated. The cover template is typically generated according to the needs and characteristics of the current job, and may not be derived from data 202 obtained from the ERP software 102. In one implementation, a main cover may be generated for the entire print job, and a plurality of sub-covers may be generated for sections within the print job. Accordingly, print jobs containing material from different business centers (e.g. retail stores, colleges within a university, voting districts, etc.) are divided by a cover with information-such as mailing information—before the materials for that business center. Accordingly, a single print job may contain many sections. This tends to reduce costs due to manipulation and logistics.

A template merger 216 is a procedure that is configured to merge the different templates—e.g. those templates extracted by the analyzer 208 and contained with the selected data 210—with the cover template 214. In most implementations of the template merger 216, all of the features of each template are merged into a single merged template 222.

A record adding procedure 218 is configured to add records to the merged PPML template (PPML/T) 222. Some of the records are data, while others are actually assets like backgrounds or images. In some cases, the size of the asset will need to be calculated.

An imposition controller 220 is configured to calculate an imposition for application to the merged template 222 with data added by the record adding procedure 218. In one implementation, where the output is headed for a digital press, the imposition may be calculated based on the destination media sheet size. For example, where the sheet size is A3, and the templates merged are A5 landscape, the imposition will result in two rows and two columns, with each of the elements rotated zero degrees.

A ticket generator 224 is configured to generate a JDF ticket 226 describing the job intent. An exemplary JDF ticket may contain pointers to the assets (images, backgrounds, fonts, etc.) used in that job. In most cases, the assets are included in the selected data 210, which was filtered and analyzed by the filter 206 and analyzer 208, and merged into a single template 222 by the template merging procedure 216.

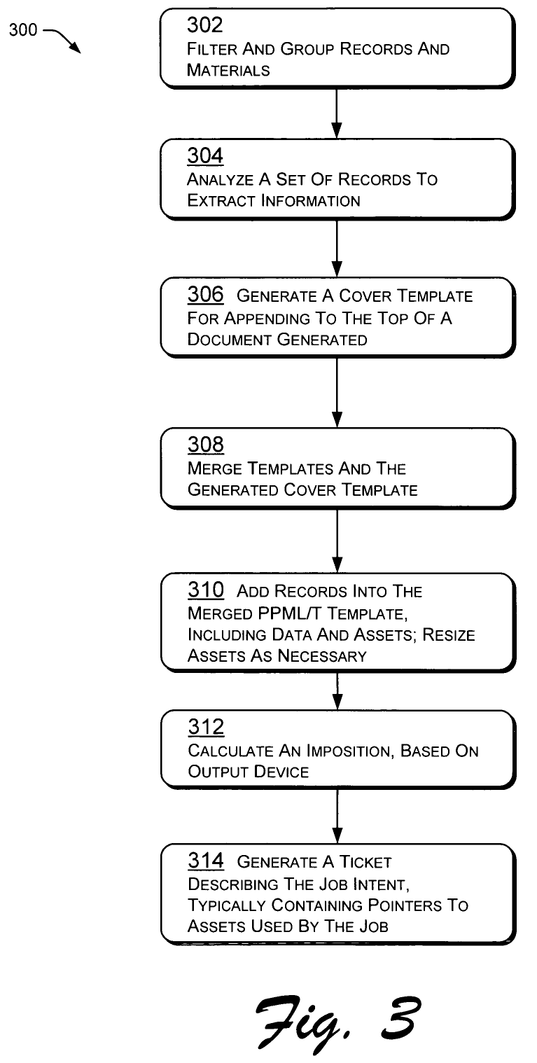

FIG. 3 is a flow diagram that describes an exemplary method 300 by which the variable data print engine 104—seen in detail in FIG. 2—may be operated. The elements of the method may be performed by any desired means, such as by the execution of processor-readable instructions defined on a processor-readable media, such as a disk, a ROM or other memory device. Also, actions described in any block may be performed in parallel with actions described in other blocks, may occur in an alternate order, or may be distributed in a manner which associates actions with more than one other block. As used herein, the phrase computer- or processor-readable media or medium can refer to any medium that can contain, store or propagate computer executable instructions. Thus, in this document, the phrase computer- or processor readable medium may refer to a medium such as an optical storage device (e.g., a CD ROM), a solid state memory device such as RAM or ROM, a magnetic storage device (e.g., a magnetic tape), or memory or media or other technology. Additionally, signals imbedded in an integrated circuit may be considered to contain instructions equivalent to those stored on media, above. In an exemplary embodiment, such signals are contained within an application specific integrated circuit (ASIC). The phrase computer- or processor-readable medium or media may also refer to signals that are used to propagate the computer executable instructions over a network or a network system, such as an intranet, the World Wide Web, the Internet or similar network.

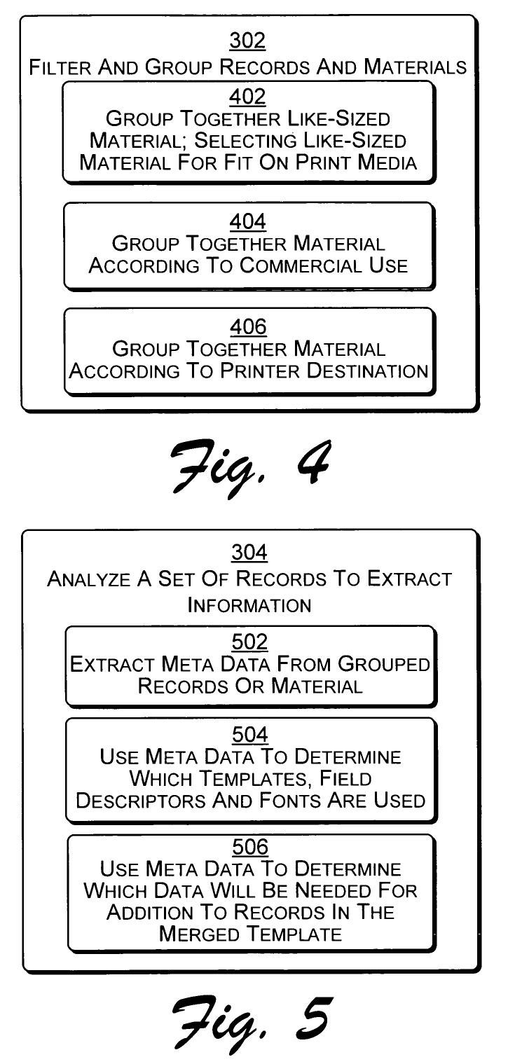

At block 302, records, data and materials are filtered and grouped. In one embodiment, the filtering task groups the records found in data 202 into subsets that can—or should—be printed together. While several examples of filters are disclosed, other filters could be constructed in a similar fashion. In particular, FIG. 4 illustrates several exemplary configurations of the filter 206 (FIG. 2), one or more of which may be implemented. At block 402, the filter 206 is utilized to filter data 202 obtained from the ERP software 102. Desired records, data and materials may be filtered from that data, and then logically grouped. The filter 206 may group together like-sized materials to form grouped records, and in particular to filter the data to result in a desired fit on print media or on a video display. Similarly, the filtering may group together material according to commercial use, at block 404, printer destination, at block 406, or other purpose.

Returning to FIG. 3, at block 304 a set of records is analyzed to extract information. In general, the analysis task is to analyze data records 202 to extract information from the records, thereby determining the templates used by those records and the field descriptors and fonts used in the templates. While several examples of analyzer procedures are disclosed, other analysis procedures could be constructed according to the suggestions found herein. In particular, FIG. 5 illustrates several exemplary configurations of the analyzer procedure 208 (FIG. 2), one or more of which may be implemented. At block 502, the analyzer 208 is utilized to analyze data 202 obtained from the ERP software 102 via the filter 206. In particular, meta data is extracted from records or material grouped by operation of the filter 206. At block 504 the meta data is used to determine which templates, field descriptors and fonts are needed or used. At block 506, meta data is used to determine which data will be needed for addition to records within the merged template.

Returning to FIG. 3, at block 306, a cover template is generated for appending to the top of a document to be generated. In a typical application, the cover template 214 is generated by a cover generator 212, and supports the printing of a cover sheet for the print job. Information for the cover template 214 may not be contained within data 202, and is typically input specially for each particular print job.

At block 308, the templates contained within data 202—which were extracted by the analyzer 208—and the cover template 214, are merged. In most applications, the merging of the templates creates a new template—a merged PPML template 222—which contains the aspects of each of each template which was merged. In one implementation, the template merging procedure 216 performs this task.

At block 310, records are added to the PPML templates, including both data and assets. The assets are resized, as necessary. In one implementation, the record adding procedure 218 performs this task.

At block 312, an imposition is calculated-such as by an imposition controller 220—based on the output device to which the merged PPML template and associated records are to be sent. The output device may be a digital press, a monitor or other output device.

At block 314, a ticket, such as a JDF ticket, describing the job intent is generated. This may be performed by the ticket generator 224 of FIG. 2. Typically, the JDF ticket contains pointers to the assets (images, backgrounds, fonts, etc.) used in the print job.

Although the above disclosure has been described in language specific to structural features and/or methodological steps, it is to be understood that the appended claims are not limited to the specific features or steps described. Rather, the specific features and steps are exemplary forms of implementing this disclosure. For example, while actions described in blocks of the flow diagrams may be performed in parallel with actions described in other blocks, the actions may occur in an alternate order, or may be distributed in a manner which associates actions with more than one other block. And further, while elements of the methods disclosed are intended to be performed in any desired manner, it is anticipated that computer- or processor-readable instructions, performed by a computer and/or processor, reading from a computer- or processor-readable media, such as a ROM, disk or CD ROM, would be preferred, but that an application specific gate array (ASIC) or similar hardware structure, could be substituted.

1. A processor-readable medium comprising processor-executable instructions for processing print data, the processor-executable instructions comprising instructions for:
filtering the print data to create grouped records;
analyzing the grouped records to extract templates used by the grouped records; and
merging the extracted templates to produce a merged template.

2. The processor-readable medium as recited in claim 1, additionally comprising instructions for:
creating a cover template for use with a document to be printed, wherein the cover template is merged with the extracted templates into the merged template.

3. The processor-readable medium as recited in claim 1, additionally comprising instructions for:
adding records to the merged template;
calculating an imposition for application to the merged template to which the records were added; and
generating a ticket describing the merged template to which the records were added, and generating pointers to assets used by the merged template.

4. The processor-readable medium as recited in claim 3, wherein analyzing the grouped records comprises instructions for:
extracting information from the grouped records; and
using the extracted information to determine which data, from among the print data, will be needed to complete the adding records to the merged template.

5. The processor-readable medium as recited in claim 3, wherein calculating an imposition for application to the merged template comprises instructions for:
modifying the merged template to purge features that are not compatible with an output device to be used.

6. The processor-readable medium as recited in claim 1, wherein filtering print data to create grouped records comprises instructions for:
grouping together like-sized material to form the grouped records; and
selecting from among the grouped records for fit on print media.

7. The processor-readable medium as recited in claim 1, wherein filtering print data to create grouped records comprises instructions for:
grouping together material according to commercial use.

8. The processor-readable medium as recited in claim 1, wherein filtering print data to create grouped records comprises instructions for:
grouping together material according to printer destination.

9. The processor-readable medium as recited in claim 1, wherein analyzing the grouped records comprises instructions for:
extracting meta data from the grouped records; and
using the meta data to determine templates used by the grouped records.

10. The processor-readable medium as recited in claim 1, wherein analyzing the grouped records comprises instructions for:
extracting information from the grouped records; and
using the extracted information to locate templates, field descriptors and fonts used by the grouped records.

11. The processor-readable medium as recited in claim 1, wherein merging the extracted templates comprises instructions for:
merging all features of the extracted templates into the merged template.

12. A system, comprising:
a filter to filter print data to create grouped records;
an analyzer to analyze the grouped records to extract templates used by the grouped records; and
a template merger to merge the extracted templates to produce a merged template.

13. The system of claim 12, additionally comprising:
a cover generator to create a cover template for use with a document to be printed, wherein the cover template is merged with the extracted templates.

14. The system as recited in claim 13, wherein the template merger is configured to merge all features of the extracted templates and the cover template into the merged template.

15. The system of claim 12, additionally comprising:
a record adder to add records to the merged template;
a imposition controller to calculate an imposition for application to the merged template to which the records were added; and
a ticket generator to create a ticket describing the merged template to which the records were added and to create pointers to assets used by the merged template.

16. The system as recited in claim 15, wherein the analyzer is configured to extract information from the grouped records and use the extracted information to determine which data, from among the print data, will be needed by the record adder when adding records to the merged template.

17. The system as recited in claim 15, wherein the imposition controller modifies the merged template to purge features that are not compatible with an output device to be used.

18. The system as recited in claim 12, wherein the filter is configured to group together like-sized material and select a plurality of the like-sized material according to fit on print media.

19. The system as recited in claim 12, wherein the filter is configured to group together material according to commercial use.

20. The system as recited in claim 12, wherein the filter is configured to group together material according to printer destination.

21. The system as recited in claim 12, wherein the analyzer is configured to extract meta data from the grouped records and use the meta data to determine templates used by the grouped records.

22. The system as recited in claim 12, wherein the analyzer is configured to extract information from the grouped records and use the extracted information to locate templates, field descriptors and fonts used by the grouped records.

23. A variable data print engine, comprising:
means for filtering print data to create grouped records;
means for analyzing the grouped records to extract templates used by the grouped records; and
means for merging the extracted templates to produce a merged template having features of all of the extracted templates.

24. The variable data print engine as recited in claim 23, additionally comprising:
means for creating a cover template for use with a document to be printed, wherein the cover template is merged with the extracted templates.

25. The variable data print engine as recited in claim 23, additionally comprising:
means for adding records to the merged template;
means for calculating an imposition for application to the merged template to which the records were added; and
means for generating a ticket describing the merged template to which the records were added, wherein the ticket includes pointers to assets used by the merged template.

26. The variable data print engine as recited in claim 23, wherein the means for filtering print data comprises:
a filter configured to filter data obtained from enterprise resource planning software.

27. The variable data print engine as recited in claim 23, wherein the means for analyzing the grouped records comprises:
an analyzer configured to extract meta data from the grouped records and use the extracted meta data to locate templates, field descriptors and fonts used by the grouped records.

28. The variable data print engine as recited in claim 23, wherein means for analyzing the grouped records comprises:
an analyzer to extracting information from the grouped records and to use the extracted information to determine which data, from among the print data, will be needed to complete the adding records to the merged template.

29. The variable data print engine as recited in claim 23, wherein means for merging the extracted templates comprises:
a template merger configured to merge all features of the extracted templates into the merged template.

30. A method for processing print data, the method comprising:
filtering the print data to create grouped records;
analyzing the grouped records to extract templates used by the grouped records; and
merging the extracted templates to produce a merged template.

31. The method as recited in claim 30, wherein filtering print data to create grouped records comprises:
filtering data obtained from enterprise resource planning software.

32. The method as recited in claim 30, wherein analyzing the grouped records comprises:
extracting meta data from the grouped records; and
using the extracted meta data to locate templates, field descriptors and fonts used by the grouped records.

33. The method as recited in claim 30, wherein analyzing the grouped records comprises:
extracting information from the grouped records; and
using the extracted information to determine which data, from among the print data, will be needed to complete the adding records to the merged template.

34. The method as recited in claim 30, wherein merging the extracted templates comprises:
merging all features of the extracted templates and a cover template into the merged template.

35. The method as recited in claim 30, additionally comprising:
calculating an imposition for application to the merged template by modifying the merged template to purge features that are not compatible with an output device to be used.
